(19) United States
(12) Patent Application Publication
(10) Pub. No.: US 2020/0327459 A1
(43) Pub. Date: Oct. 15, 2020

(54) RIDE RESERVATION USER SUPPORT APPARATUS AND RIDE RESERVATION USER SUPPORT METHOD

(71) Applicant: SUZUKI MOTOR CORPORATION, Hamamatsu-shi (JP)

(72) Inventors: Akira AKITA, Hamamatsu-shi (JP); Hitoshi KUBOTA, Hamamatsu-shi (JP); Atsuto SUYAMA, Tokyo (JP)

(73) Assignee: SUZUKI MOTOR CORPORATION, Hamamatsu-shi (JP)

(21) Appl. No.: 16/839,843

(22) Filed: Apr. 3, 2020

(30) Foreign Application Priority Data
Apr. 10, 2019 (JP) 2019-074687

(51) Int. Cl. G06Q 10/02; G06Q 50/30; G01C 21/34; H04W 4/029

(52) U.S. Cl. CPC G06Q 10/02; G06Q 50/30; H04W 4/029; G01C 21/3438; G01C 21/3415

(57) ABSTRACT

A ride reservation user support apparatus includes a reservation information acquirer, a location information acquirer, a route information acquirer, a route deviation detector and a notification provider. The reservation information acquirer acquires ride reservation information for identifying a device of a user and a scheduled boarding location where the user boards a vehicle. The location information acquirer acquires location information of the device. The route information acquirer acquires route information that indicates a predicted route, which is predicted to be used by the user, from a location indicated by the location information to the scheduled boarding location. The route deviation detector determines whether the device deviates from the predicted route based on the location information and the route information. The notification provider causes the device to provide a notification to the user in a case where the device deviates from the predicted route.

### CROSS-REFERENCE TO RELATED APPLICATIONS

The disclosure of Japanese Patent Application No. 2019-074687 filed on Apr. 10, 2019, including specification, drawings and claims is incorporated herein by reference in its entirety.

### BACKGROUND

The present invention relates to a ride reservation user support apparatus and a ride reservation user support method.

With respect to a ride reservation system in which a user reserves use of a shared bus, it is desirable, from the viewpoint of convenience of the user, that even in a case where the user is not on time when the shared bus arrives at a scheduled boarding location, the shared bus waits as long as possible.

However, when the shared bus waits even in a case where the user does not make it to the scheduled boarding location in time, there is a high possibility that a delay will occur in an operation schedule of the shared bus, which is not preferable. Therefore, it is conceivable to cancel a ride reservation under a certain condition.

For example, it has been proposed that, in a case of going to a destination by a combination of general transportation and on-demand transportation for which a ride reservation is possible, an arrival date and time of arriving at a departure location of a route portion of the reserved on-demand transportation is recalculated based on general transportation delay information, and that a reservation system has the reservation canceled in a case of not making it in time for the reserved on-demand transportation based on a result of the recalculation (see Patent Literature 1 and the like).

Patent Literature 1: JP-A-2014-10818

### SUMMARY

According to an advantages aspect of the invention, there is provided a ride reservation user support apparatus including:

a reservation information acquirer configured to acquire ride reservation information for identifying a device of a user and a scheduled boarding location where the user boards a vehicle;

a location information acquirer configured to acquire location information of the device;

a route information acquirer configured to acquire route information that indicates a predicted route, which is predicted to be used by the user, from a location indicated by the location information to the scheduled boarding location;

a route deviation determination unit configured to determine whether the device deviates from the predicted route based on the location information and the route information; and

a notification provision unit configured to cause the device to provide a notification to the user in a case where the device deviates from the predicted route.

According to another advantages aspect of the invention, there is provided a ride reservation user support method including:

a step of acquiring ride reservation information for identifying a device of a user and a scheduled boarding location where the user boards a vehicle;

a step of acquiring location information of the device;

a step of acquiring route information that indicates a predicted route, which is predicted to be used by the user, from a location indicated by the location information to the scheduled boarding location;

a step of determining whether the device deviates from the predicted route based on the location information and the route information; and

a step of causing the device to provide a notification to the user in a case where the device deviates from the predicted route.

### BRIEF DESCRIPTION OF DRAWINGS

FIG. 1 is a schematic diagram illustrating an entire shared bus reservation system, to which a ride reservation user support apparatus is applied, according to a first embodiment.

FIG. 2 is a functional block diagram illustrating a reservation manager of a vehicle management server according to the first embodiment.

FIG. 3 is a functional block diagram illustrating a device according to the first embodiment.

FIG. 4 is a functional block diagram illustrating a bus according to the first embodiment.

FIG. 5 is a sequence diagram illustrating processing and data exchange of the shared bus reservation system according to the first embodiment.

FIG. 6 is a flowchart illustrating each step of user support processing of the shared bus reservation system according to the first embodiment.

FIG. 7 is a flowchart illustrating each step of notification provision processing of the shared bus reservation system according to the first embodiment.

FIGS. 8A and 8B are schematic diagrams illustrating an example of a screen including a notification provided to the device in the shared bus reservation system according to the first embodiment.

FIG. 9 is an illustrative diagram illustrating a specific example of user support of the shared bus reservation system according to the first embodiment.

FIG. 10 is another illustrative diagram illustrating a specific example of user support of the shared bus reservation system according to the first embodiment.

FIG. 11 is a diagram illustrating an example of a hardware configuration of a server and the device according to the first embodiment.

FIG. 12 is a functional block diagram illustrating a reservation manager of a vehicle management server according to a second embodiment.

FIG. 13 is a flowchart illustrating a part of user support processing of a shared bus reservation system according to the second embodiment.

FIG. 14 is a flowchart illustrating a part of notification provision processing of the shared bus reservation system according to the second embodiment.

FIG. 15 is a flowchart illustrating a part of user support processing of a shared bus reservation system according to a third embodiment.

### DETAILED DESCRIPTION OF EXEMPLIFIED EMBODIMENTS

In a case where the user walks to the scheduled boarding location of the reserved shared bus, the technique, in which the general transportation delay information is used, as described in Patent Literature 1 cannot be applied.

The present invention has been made in view of the foregoing, and an object thereof is to provide a ride reservation user support apparatus and a ride reservation user support method that are capable of improving convenience for a user and reducing influence on a vehicle operation schedule.

Hereinafter, embodiments of the present invention will be described in detail with reference to the accompanying drawings. Although an example is described below in which a ride reservation user support apparatus and a method thereof according to the present invention are applied to a driverless shared bus that performs a scheduled operation, an application subject of the present invention is not limited thereto and modifications can be made. For example, the ride reservation user support apparatus according to the present invention may be applied to a driverless vehicle such as a taxi, which operates on a premise of being allocated in response to a request from a user and only allowing the user and a companion thereof to board the vehicle. The type of the vehicle is not particularly limited, and any type of vehicle may be used, for example, a saddle type vehicle such as a four-wheeled vehicle, a two-wheeled vehicle, and a three-wheeled vehicle. A crew member may be on board the driverless vehicle. Further, the vehicle may be a manual driving vehicle that is driven by a driver, and a vehicle in which a driving support apparatus is mounted.

### SUMMARY OF THE INVENTION

With respect to a ride reservation system of a driverless bus that is regularly operated, it is considered, from the viewpoint of ensuring regular operability, that it is effective to cancel a ride reservation under a certain condition in a case where a user does not go toward a scheduled boarding location.

Therefore, it is considered to cancel the ride reservation based on a relative relationship between a current location of the user and the scheduled boarding location. For example, it is possible to cancel the ride reservation on a condition such as one that the user is away from the scheduled boarding location or one that the user is going in a direction different from that leading to the scheduled boarding location. However, among these cases, in one case where the user temporarily goes away from the scheduled boarding location because there is a building in a route to the scheduled boarding location or because there is an obstacle such as road work being underway, or in one case where the user temporarily goes in a different direction, the reservation is cancelled and the convenience for the user is significantly impaired.

In order to avoid such situations, it is considered that the user requests the vehicle to wait. The vehicle may wait only in a case where there is a request from the user, and the convenience for the user is improved. However, since whether to make a request depends on an initiative of the user, there is a concern about effectiveness. In particular, in a case where the user is an elderly person, such a concern increases.

As a result of intensive studies, the present inventors have found that in a case where a movement route of the device of the user deviates from a predetermined route leading to the scheduled boarding location of the user, providing an appropriate notification, checking an intention of the user and taking a countermeasure in accordance therewith contributes to reduction of influence on the convenience for the user and on the vehicle operation schedule, and have completed the present invention.

That is, a ride reservation user support apparatus according to the present embodiment at least includes: a reservation information acquirer configured to acquire ride reservation information for identifying a device of a user and a scheduled boarding location where the user boards a vehicle; a location information acquirer configured to acquire location information of the device; a route information acquirer configured to acquire route information that indicates a predicted route, which is predicted to be used by the user, from a location indicated by the location information to the scheduled boarding location; a route deviation determination unit configured to determine whether the device deviates from the predicted route based on the location information and the route information; and a notification provision unit configured to cause the device to provide a notification to the user in a case where the device deviates from the predicted route.

A ride reservation user support method according to the present embodiment at least includes: a step of acquiring ride reservation information for identifying a device of a user and a scheduled boarding location where the user boards a vehicle; a step of acquiring location information of the device; a step of acquiring route information that indicates a predicted route, which is predicted to be used by the user, from a location indicated by the location information to the scheduled boarding location; a step of determining whether the device deviates from the predicted route based on the location information and the route information; and a step of causing the device to provide a notification to the user in a case where the device deviates from the predicted route.

### First Embodiment

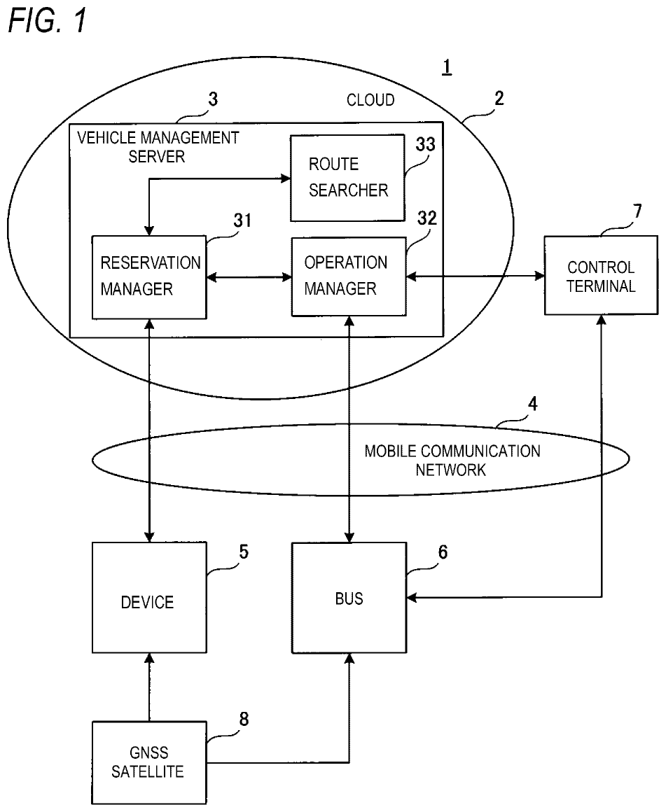

Hereinafter, a shared bus operation system to which a ride reservation user support apparatus is applied according to a first embodiment of the present invention will be described in detail with reference to FIGS. 1 to 11.

(Entire System)

FIG. 1 is a schematic diagram illustrating an entire shared bus reservation system to which a ride reservation user support apparatus is applied according to the first embodiment. A shared bus reservation system 1 illustrated in FIG. 1 includes a vehicle management server 3 that is provided in cloud 2. A device 5 and a bus 6 are communicably connected to the vehicle management server 3 via a mobile communication network 4 that is an example of a network. A control device 7 is connected to the vehicle management server 3 via the Internet (not illustrated). The control device 7 is communicably connected to the bus 6 via the mobile communication network 4. The device 5 and the bus 6 are configured to be capable of receiving a GNSS signal from a GNSS satellite 8. Note that one device 5 and one bus 6 are illustrated in FIG. 1 for convenience, and a plurality of devices 5 and a plurality of buses 6 may exist.

(Vehicle Management Server)

The vehicle management server 3 includes functions of a reservation manager 31, an operation manager 32, and a route searcher 33. The reservation manager 31 is an example of the ride reservation user support apparatus according to the present invention. Details of support for a user will be described below. The reservation manager 31 is configured to receive a ride reservation from the user to generate ride reservation information (to be described below) and provide the ride reservation information to the operation manager 32.

The operation manager 32 is configured to run the bus 6 along an operation route following scheduled time points according to an operation schedule, compass an operation state and an in-vehicle state of the bus 6, and output the operation state and the in-vehicle state to the control device 7. In addition, the operation manager 32 causes the bus 6 to perform a series of operations (hereinafter, referred to as “pick-up operations”) of stopping at a bus stop, allowing the user to board and departing.

The route searcher 33 is configured to refer to map data and search for a predicted route, which is predicted to be used by the user, from a current location of the device 5 to the bus stop, based on the information from the reservation manager 31. The route searcher 33 is configured to calculate expected arrival times of arriving at the bus stop from current locations of the device 5 and the bus 6. The route searcher 33 may have the same configuration as that provided in a general car navigation apparatus and in a route search server for a route search service.

### (Reservation Manager)

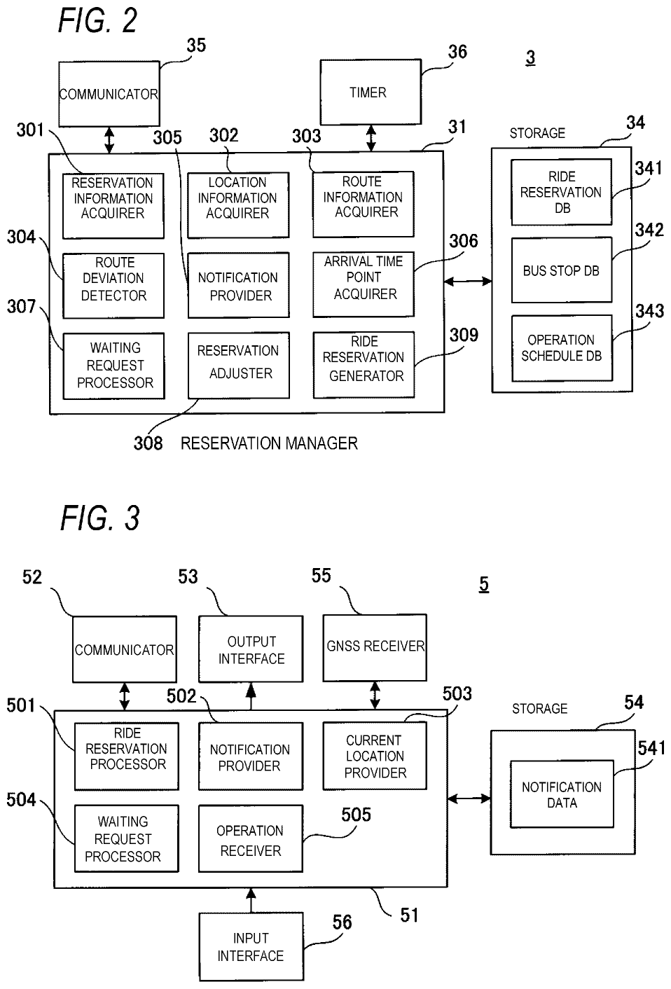

FIG. 2 is a functional block diagram illustrating the reservation manager of the vehicle management server 3 according to the first embodiment. The reservation manager 31 includes, as functions thereof, a reservation information acquirer 301, a location information acquirer 302, a route information acquirer 303, a route deviation detector 304, a notification provider 305, an arrival time acquirer 306, a waiting command processor 307, a reservation adjuster 308, and a ride reservation generator 309.

The reservation information acquirer 301 is configured to refer to a ride reservation database (DB) 341 stored in a storage 34 and acquire the ride reservation information performed by the user of the device 5. The ride reservation information at least contains identification information that makes it possible to identify the device 5 of the user and the bus stop where the user boards the vehicle. Format and the like of the identification information are not particularly limited. The bus stop is an example of the scheduled boarding location of the present invention.

The location information acquirer 302 is configured to control a communicator 35 and receive current location information from the device 5 and the bus 6.

The route information acquirer 303 is configured to input the current location information of the device 5 and location information of the bus stop to the route searcher 33, and acquire, as a response, route information that indicates a predicted route, which is predicted to be used by the user, from a location indicated by the current location information to the bus stop. Here, the location information of the bus stop is represented by, for example, latitude and longitude, and is not particularly limited. The location information of the bus stop is managed by the operation manager 32 (see FIG. 1) based on the identification information that makes it possible to identify the bus stop and that is contained in the ride reservation information, and can be acquired by referring to the bus stop database 342 stored in the storage 34, and the present invention is not particularly limited thereto.

The route deviation detector 304 is configured to perform processing of determining whether the device 5 deviates from the predicted route based on the location information of the device 5 and the route information (hereinafter, referred to as “route deviation determination processing”). Details of the route deviation determination processing will be described below.

The notification provider 305 is configured to perform processing of causing the device 5 to provide a notification to the user (hereinafter, referred to as “notification provision processing”). Specifically, the notification provider 305 controls the communicator 35 to transmit a signal that commands the device 5 to perform a desired notification (hereinafter, referred to as a “notification command signal”). The notification command signal contains, for example, the identification information for identifying notification content, and the predicted arrival times of the user and the bus 6, and is not particularly limited. Details of the notification provision processing will be described below.

The arrival time acquirer 306 is configured to input the current location information of the device 5 or the bus 6 and the location information of the bus stop to the route searcher 33 and acquire, as a response, a time point at which the device 5 or the bus 6 is predicted to arrive at the bus stop (hereinafter, referred to as a “predicted arrival time”).

The waiting command processor 307 is configured to transmit a signal that commands the bus 6 to wait at the bus stop (hereinafter, referred to as a “waiting command signal”) to the bus 6, in response to a waiting request signal (to be described below) received from the device 5 by the communicator 35. Further, the waiting command processor 307 is configured to transmit a signal that commands performing of release of the waiting at the bus stop (hereinafter, referred to as a “waiting release signal”) to the bus 6.

The reservation adjuster 308 is configured to perform processing of cancelling a ride reservation by the user after a predetermined time period elapses since the bus 6 arrives at the bus stop (hereinafter, referred to as “reservation cancellation processing”), in a state where the waiting command processor 307 transmits a waiting command signal to the bus 6 in response to a waiting request signal from the device 5 and does not transmit a waiting release signal (hereinafter, referred to as a “waiting continuation state”).

The ride reservation generator 309 is configured to perform processing of communicating with the device 5 via the communicator 35, receiving a ride reservation, generating ride reservation information, and registering the ride reservation information in a ride reservation database 341. Data exchange between the ride reservation generator 309 and the device 5 and various types of processing, which are for receiving a ride reservation, are the same as those of a reservation system of a general transport facility, and a description thereof will be omitted.

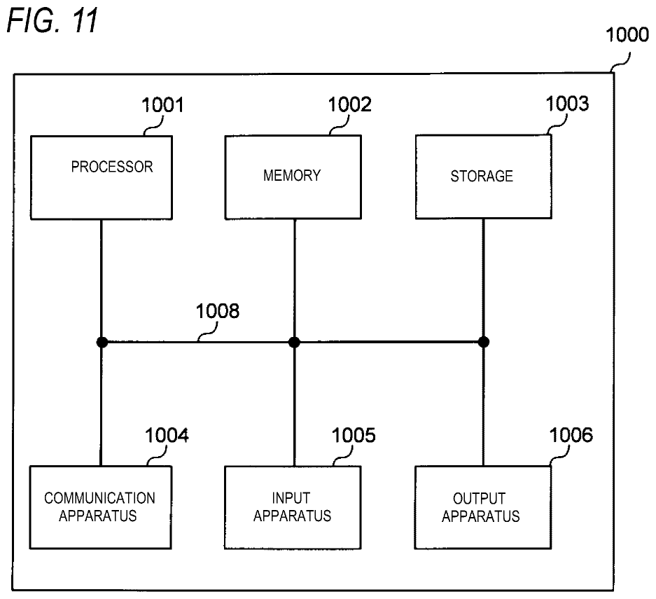

Each function of the reservation manager 31 as described above can be realized by a processor 1001, of a computer apparatus 1000 (see FIG. 11) that implements the vehicle management server 3, executing a program, controlling the communicator 35 to transmit and receive signals and the like, or writing and reading data or the like to and from the storage 34, as will be described below.

(Device)

FIG. 3 is a functional block diagram illustrating the device 5 according to the first embodiment. As illustrated in FIG. 3, the device 5 includes a ride reservation processor 501, a notification provider 502, a current location provider 503, a waiting request processor 504, and an operation receiver 505 as functions to be realized by a calculator 51.

The ride reservation processor 501 is configured to communicate with the ride reservation generator 309 (see FIG. 2) of the vehicle management server 3 via the mobile communication network 4 (see FIG. 1) by a communicator 52 to make a ride reservation. Data exchange with the ride reservation generator 309 and various types of processing, which are for making a ride reservation, are the same as those of a reservation system of a general transport facility, and a description thereof will be omitted.

The notification provider 502 is configured to control an output interface 53 in response to a notification command signal from the notification provider 305 (see FIG. 2) to perform a notification for the user. The notification is performed by, for example, displaying notification content on a display unit that is an example of the output interface 53, and the present invention is not particularly limited thereto. For example, the notification content may be output as speech from a speaker that is an example of the output interface 53. The notification content may be based on notification data 541 stored in a storage 54, or may be contained in a notification command signal or be based on information (for example, the predicted arrival time) received from the notification provider 305 in association therewith.

The current location provider 503 is configured to perform processing of receiving a GNSS signal from the GNSS satellite 8 (see FIG. 1) by a GNSS receiver 55 to acquire current location information and controlling the communicator 52 to transmit the current location information to the location information acquirer 302 of the vehicle management server 3.

The waiting request processor 504 is configured to transmit a signal that requests a waiting command for the bus 6 (hereinafter, referred to as a “waiting request signal”) to the waiting command processor 307 (see FIG. 2) of the vehicle management server 3 via the communicator 52 in response to an operation of the user. The operation of the user is performed via an input interface 56, is received by the operation receiver 505 and is transmitted to the waiting request processor 504.

Each function of the device 5 as described above can be realized by the processor 1001, of the computer apparatus 1000 (see FIG. 11) that implements the device 5, executing a program, controlling the communicator 52 to transmit and receive signals and the like, or writing and reading data or the like to and from the storage 54, as will be described below.

In particular, in a case where various functions of the device 5, as typified by a smartphone or a tablet, can be realized with an application program executed on an operation system (OS), a part or all of the functions described with reference to FIG. 3 may be realized with the application program.

(Bus)

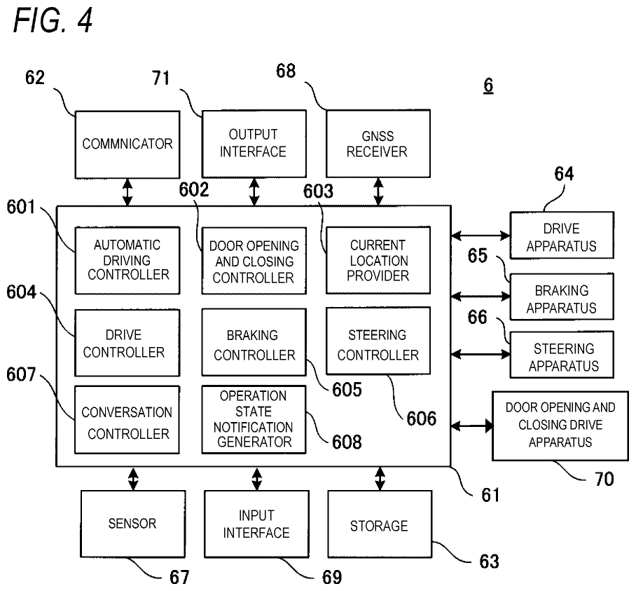

FIG. 4 is a functional block diagram illustrating the bus 6 according to the first embodiment. With respect to a configuration that the bus 6 is naturally provide with (for example, a wheel, a seat and a headlight) and a configuration that the bus 6 is optionally provided with (for example, an air conditioning apparatus), only those necessary for the description of the present embodiment are illustrated, and others are omitted.

As illustrated in FIG. 4, the bus 6 includes an automatic driving controller 601, a door opening and closing controller 602, a current location provider 603, a drive controller 604, a braking controller 605, a steering controller 606, a conversation controller 607, and an operation state notification generator 608 as functions realized by a calculator 61.

The automatic driving controller 601 is configured to perform communication using a communicator 62 via the mobile communication network 4 (see FIG. 1) to acquire information on an operation schedule from the operation manager 32 of the vehicle management server 3, cause the unmanned bus to travel automatically along an operation route according to the operation schedule, and perform a pick-up operation at a bus stop for which a ride reservation is made.

First, the automatic driving controller 601 refers to map data (not illustrated) stored in a storage 63, and causes the unmanned bus to travel along the operation route specified by the operation schedule.

The automatic driving controller 601 causes the drive controller 604 to control a driving apparatus 64 such as an electric motor to perform acceleration and deceleration of the bus 6 during automatic travelling of the unmanned bus. In addition, the automatic driving controller 601 causes the braking controller 605 to control a braking apparatus 65 such as a brake to perform braking and stopping of the bus 6. Further, the automatic driving controller 601 causes the steering controller 606 to control a steering apparatus 66 such as a steering motor to perform a right turn or a left turn and the like of the bus 6.

More specifically, the automatic driving controller 601 compasses a distance to a front vehicle in accordance with a detection signal from a front camera that is one of the sensor 67, and controls the driving apparatus 64 and the braking apparatus 65 so as to maintain an inter-vehicle distance. Here, in addition to the front camera, a front sensor (millimeter wave radar, LI DAR, or the like) may be used.

When an obstacle is detected based on the detection signal from the front camera that is one of the sensor 67, the automatic driving controller 601 performs control of controlling the braking apparatus 65 to stop the bus 6, or performs control of controlling the steering apparatus 66 to change a direction of the bus 6 to avoid the obstacle.

As described, the automatic driving controller 601 is configured to be capable of performing automatic driving corresponding to, for example, an automatic driving level 4 or 5 defined by SAE International, and the present invention is not particularly limited thereto.

At the time of allowing the user to board at the bus stop, the automatic driving controller 601 controls the steering apparatus 66 to bring the bus 6 close to a road shoulder in the vicinity of the bus stop, and next controls the braking apparatus 65 to stop the bus 6. Thereafter, the automatic driving controller 601 causes the door opening and closing controller 602 to control a door opening and closing drive apparatus 70 to open a door to allow the user to board. Such a series of operations of stopping at the bus stop will be hereinafter referred to as bus stop stopping operations.

Further, the automatic driving controller 601 confirms that the door is closed, by using a door sensor which is one of the sensor 67, and confirms that the user is seated and wears a seat belt, by using a seat belt wearing sensor which is one of the sensor 67 (hereinafter, referred to as “safety confirmation”), and causes the bus 6 to depart after securing the safety of the user. Such a series of operations of the bus 6 departing from the bus stop will be hereinafter referred to as bus stop departing operations. The automatic driving controller 601 controls the communicator 62 to transmit a result of safety confirmation performed in the bus stop departing operation to the operation manager 32 (see FIG. 1). The operation manager 32 records the result of safety confirmation in the storage 34 (see FIG. 2), and further outputs the result of safety confirmation to the control device 7 and notifies a person in charge of the control.

The current location provider 603 is configured to perform processing of receiving a GNSS signal from the GNSS satellite 8 (see FIG. 1) by a GNSS receiver 68 to acquire current location information and controlling the communicator 62 to transmit the current location information to the location information acquirer 302 of the vehicle management server 3.

The conversation controller 607 is configured to control the communicator 62 to communicate with the control device 7 via the mobile communication network 4 (FIG. 1), and implement a conversation with the user by the person in charge of the control. In the bus 6, speech of the user is received by a microphone, which is one of an input interface 69, and speech of the person in charge of the control is output from a speaker, which is one of an output interface 71. Instead of or in addition to speech, text display may be performed on a display.

The operation state notification generator 608 is configured to generate an operation state notification such as stopping at the bus stop, boarding of the user, and departure from the bus stop, by using the door sensor, the seat belt wearing sensor, information from the automatic driving controller 601 or the like, and control the communicator 62 to transmit the operation state notification to the reservation manager 31 and the operation manager 32 via the mobile communication network 4 (see FIG. 1).

Each function of the bus 6 as described above can be realized by an electronic control unit (ECU) and/or a vehicle onboard computer. For example, a configuration of the vehicle onboard computer is basically the same as that of the computer apparatus 1000 (see FIG. 11) that implements the device 5 as will be described below. Therefore, each function of the bus 6 can be realized by the processor 1001 executing a program, controlling the communicator 62 to transmit and receive signals and the like, or writing and reading data or the like to and from the storage 63. Further, each function of the bus 6 may be realized by a microcontroller (microcomputer) as by an ECU.

(On-Demand Transportation)

In the first embodiment, a case, where the bus 6 is stopped at a bus stop for which a ride reservation is made in a shared bus that performs a regular operation, is described as an example. As another mode of a transportation facility to which the present invention is applied, on-demand transportation (also referred to as demand type transportation) can be exemplified. The on-demand transportation includes the following types, and is not particularly limited. A subject matter of the present invention is a countermeasure in a case where a user does not appear at a bus stop for which a reservation is made, and does not depend on an operation mode of a vehicle.

(1) Fixed Route Type

It patrols a fixed route as a general route bus does and stops at a bus stop, but only operates in a case where a ride reservation is made.

(2) Random Route Door-to-Door Type

Although an operation area is determined, an operation route is not fixed but is based on a request, as in a general taxi business, and a boarding and alighting location is not designated. In this case, a scheduled boarding location may be any location designated by the user, and may be, for example, home thereof.

(3) Alternative Route and Area Demand Type

It is based on a fixed route type, and operates to an alternative route or an area predetermined in a case where a reservation is made.

(4) Random Route Meeting Point Type

An operation route is not fixed, and it operates along a shortest route connecting bus stops for which reservations are made.

However, the present embodiment is not limited to the on-demand transportation, and can also be applied to reservation-based vehicle allocation of a taxi or the like.

(Processing from Ride Reservation to Bus Departure)

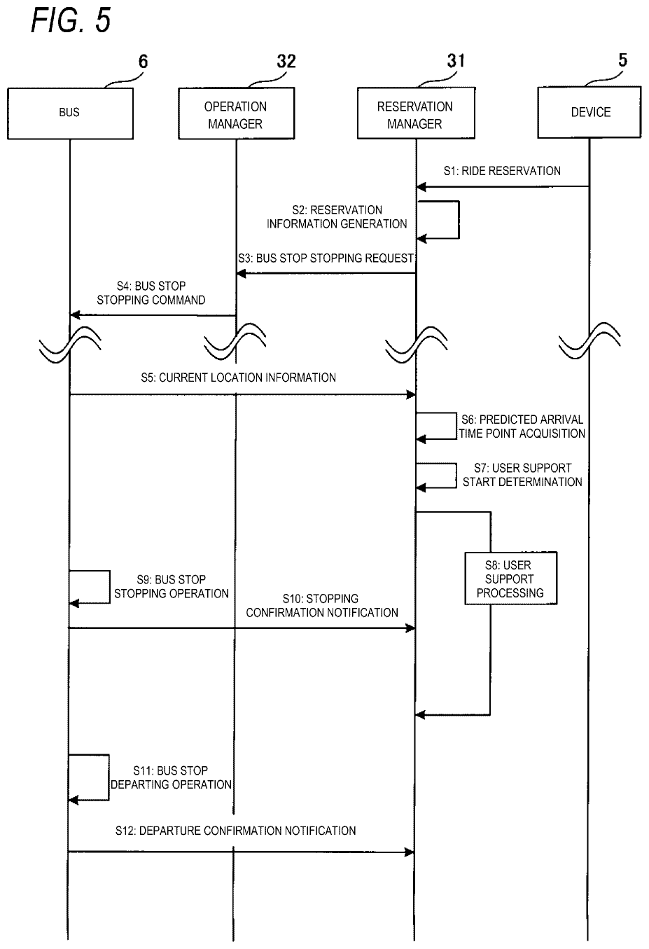

FIG. 5 is a sequence diagram illustrating processing and data exchange of the shared bus reservation system 1 according to the first embodiment. As illustrated in FIG. 5, first, a ride reservation is made from the device 5 to the reservation manager 31 of the vehicle management server 3 (S1). At this time, the reservation manager 31 receives, from the device 5, information on, for example, the user, the device 5 of the user, a using date, a using route, a boarding bus stop, and an alighting bus stop.

The reservation manager 31 generates ride reservation information based on the information received from the device 5 (S2). The ride reservation information contains, for example, a user ID for identifying the user, a device ID for identifying the device 5 of the user, the using date, a using route ID for identifying the using route, a boarding bus stop ID for identifying the boarding bus stop, an alighting bus stop ID for identifying the alighting bus stop, and a fare ID for identifying a fare that is predetermined in accordance with a riding section of the user. The reservation manager 31 registers the generated ride reservation information in the ride reservation database 341 (see FIG. 2).

Next, the reservation manager 31 transmits a request of stopping at the boarding bus stop (hereinafter, referred to as a “bus stop stopping request”) to the operation manager 32 in accordance with the ride reservation information (S3). The bus stop stopping request contains the using date, the using route ID and the boarding bus stop ID.

In response to the bus stop stopping request, the operation manager 32 transmits a command of performing stopping at the bus stop (hereinafter, referred to as a “bus stop stopping command”) to the bus 6. More specifically, based on the using date and the using route ID contained in the bus stop stopping request, the operation manager 32 searches an operation schedule database 343 stored in the storage 34 (see FIG. 2) to identify the bus 6 to board, and transmits the bus stop stopping command to the identified bus 6. The bus stop stopping command contains, for example, a bus stop ID for identifying a bus stop of a scheduled boarding location.

When leaving for operation, the bus 6 regularly transmits current location information to the location information acquirer 302 (see FIG. 2) of the reservation manager 31 (S5). In FIG. 5, only one time of transmission is illustrated for convenience.

The arrival time acquirer 306 of the reservation manager 31 inputs the current location information of the bus 6 acquired by the location information acquirer 302 to the route searcher 33 (see FIG. 2), and acquires a predicted arrival time of arriving at the bus stop of the bus 6 (hereinafter referred to as an “estimated bus arrival time”) (S6). The estimated bus arrival time is an example of a predicted vehicle arrival time of the present invention. Next, the notification provider 305 determines whether to start user support processing (S8) or not, based on whether the predicted arrival time of the bus 6 is within a predetermined time (for example, 10 minutes) from a current time point (S7). The current time point can be acquired from, for example, a timer (real-time clock circuit or the like) 36 (see FIG. 2). Details of the user support processing (S8) will be described below.

Thereafter, when the bus 6 arrives at the bus stop, the automatic driving controller 601 (see FIG. 4) performs the bus stop stopping operations and stops the bus at the bus stop (S9). Next, the operation state notification generator 608 transmits a notification indicating that the bus 6 is stopped at the bus stop (hereinafter, referred to as a “stopping confirmation notification”) to the reservation manager 31 (S10).

Thereafter, the automatic driving controller 601 performs the bus stop departing operations and causes the bus to depart from the bus stop (S11). Next, the operation state notification generator 608 transmits a notification indicating that the bus 6 has departed from the bus stop (hereinafter, referred to as a “departure confirmation notification”) to the reservation manager 31 (S12).

(User Support Processing)

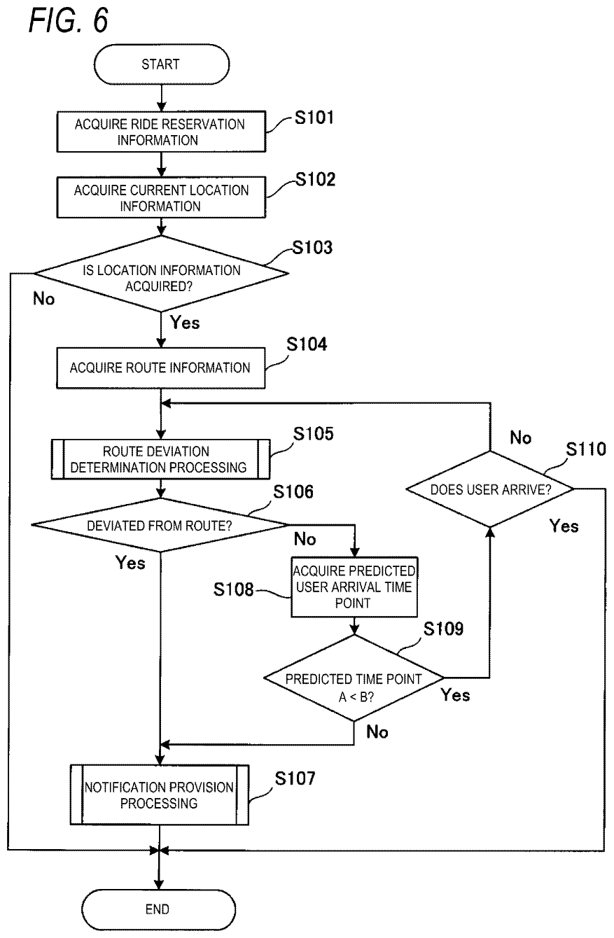

FIG. 6 is a flowchart illustrating each step of the user support processing of the shared bus reservation system 1 according to the first embodiment. As illustrated in FIG. 6, in the reservation manager 31 (see FIG. 2), first, the location information acquirer 302 acquires ride reservation information from the ride reservation database 341 (S101).

Next, the location information acquirer 302 requests and acquires current location information from the device 5 of a user, who has made a ride reservation to the bus 6, based on the ride reservation information (S102).

Next, the location information acquirer 302 determines whether the current location information has been acquired (S103). If the determination in S103 is No, the processing is ended. If the determination is Yes, the route information acquirer 303 acquires route information indicating a predicted route, which is predicted to be used by the user, from a location indicated by the current location information of the device 5 to a bus stop, based on the current location information of the device 5 (S104). Details of the predicted route will be described below.

(Route Deviation Determination Processing)

Thereafter, based on the route information acquired in S104 and latest current location information acquired from the device 5, the route deviation detector 304 performs route determination processing of determining whether the device 5 deviates from the predicted route (S105).

In the present embodiment, it is possible to use, in the route deviation determination processing, a method same as that in the determination of necessity of a route re-search (re-route) performed by a general car navigation apparatus. For example, a location indicated by the current location information acquired from the device 5 is plotted on a map. A movement route indicated by a plurality of plotted locations and the predicted route are compared, making it possible to determine whether to perform a route re-search.

After the route deviation determination processing (S105) ends, based on a result thereof, it is determined whether the user deviates from the predicted route (S106). If the determination in S106 is Yes, the process proceeds to the notification provision processing (S107).

If the determination in S106 is No, the arrival time acquirer 306 inputs the latest current location information, which is acquired by the location information acquirer 302 from the device 5, to the route searcher 33, and acquires, as a response, a predicted arrival time at which the device 5, that is, the user is predicted to arrive at the bus stop (hereinafter, referred to as a “predicted user arrival time”) (S108). Further, based on whether the predicted user arrival time (A) is earlier than the estimated bus arrival time (B) (A<B), the notification provider 305 determines whether the user makes it in time (S109). If the determination in S109 is No, the process proceeds to the notification provision processing (S107) because the user does not make it in time. On the other hand, if the determination in S109 is Yes, the process does not proceed to the notification provision processing (S107) but proceeds to S110 because the user makes it in time.

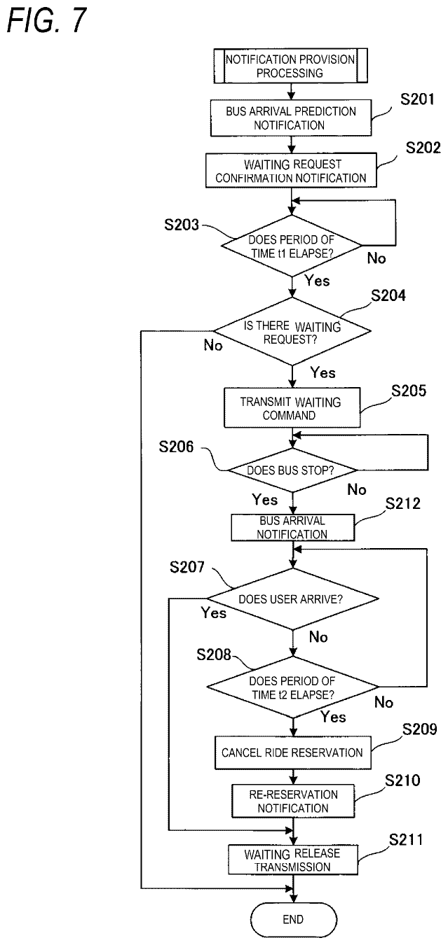

The notification provider 305 determines whether the user arrives at the bus stop (S110). The determination as to whether the user arrives at the bus stop is the same as S207 (to be described below) illustrated in FIG. 7. If the determination in S110 is Yes, the process ends, and if the determination is No, the process returns to S105.

(Notification Provision Processing)

FIG. 7 is a flowchart illustrating each step of the notification provision processing of the shared bus reservation system 1 according to the first embodiment. In the notification provision processing (S107 in FIG. 6), as illustrated in FIG. 7, first, the notification provider 305 transmits a notification command signal, which commands a notification of the estimated bus arrival time, to the device 5 (S201). Next, the notification provider 305 transmits another notification command signal, which commands performing of a notification of confirming the waiting necessity of the vehicle, to the device 5 (hereinafter, referred to as a “waiting request confirmation notification”) (S202). An order of the bus arrival prediction notification (S201) and the waiting request confirmation notification (S202) is not limited, and may be reversed.

Thereafter, the notification provider 305 determines whether a predetermined time period t1 elapses since the waiting request confirmation notification (S202) is performed (S203). If the determination in S203 is No, the determination is repeated. If the determination in S203 is Yes, the notification provider 305 determines whether a waiting request signal is received from the device 5 (S204). If the determination in S204 is No, the notification provision processing ends. Thereafter, the user support processing illustrated in FIG. 6 ends.

If the determination in S204 is Yes, the waiting command processor 307 transmits a waiting command signal to the bus 6 (S205). Next, the notification provider 305 determines whether the bus 6 stops at a bus stop, based on whether the stopping confirmation notification (S10 in FIG. 5) is received from the operation state notification generator 608 of the bus 6 (S206). If the determination in S206 is No, the process returns to S206. Accordingly, S206 is repeated until the bus stops. On the other hand, if the determination in S206 is Yes, the notification provider 305 transmits a notification command signal that commands performing of a notification indicating that the bus 6 arrives at the bus stop (hereinafter, referred to as a “bus arrival notification”) (S212).

Next, the notification provider 305 determines whether the user arrives at the bus stop (S207). Whether the user arrives at the bus stop can be determined based on, for example, whether a location indicated by the latest current location information of the device 5 is within a predetermined range from the bus stop, and the present invention is not particularly limited thereto. If the determination in S207 is Yes, the process proceeds to S211 (to be described below).

If the determination in S207 is No, the reservation adjuster 308 determines whether a predetermined time period t2 elapses since the stopping confirmation notification (S10 in FIG. 5) is received from the bus 6 (S208). If the determination in S208 is No, the process returns to S207. If the determination in S208 is Yes, the reservation adjuster 308 cancels the ride reservation (S209). In a case where the ride reservation is canceled, the notification provider 305 transmits a notification command signal, which commands a notification of prompting a re-reservation of remaking a ride reservation, to the device 5 (S210). Thereafter, the waiting command processor 307 transmits a waiting release signal to the bus 6 (S211), and the notification provision processing ends. Thereafter, the user support processing illustrated in FIG. 6 ends.

(Screen Example)

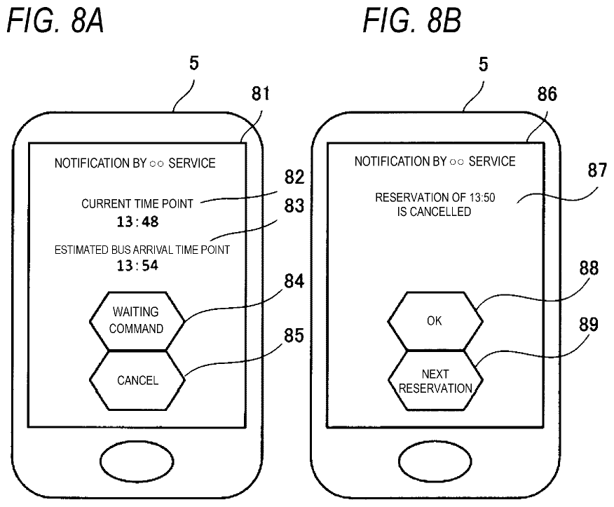

FIGS. 8A and 8B are schematic diagrams illustrating a screen example including a notification provided to the device 5 in the shared bus reservation system 1 according to the first embodiment. FIG. 8A is a screen example including both an estimated bus arrival time and a confirmation of waiting necessity. A screen 81 illustrated in FIG. 8A is displayed on a display, which is an example of the output interface 53, by the notification provider 502 (see FIG. 3) of the device 5 in response to the notification command signal in steps S201 and S202 illustrated in FIG. 7. As illustrated in FIG. 8A, the screen 81 includes a current time point 82, an estimated bus arrival time 83, a waiting command button 84, and a cancel button 85. The waiting command button 84 is a user interface for receiving an operation of the user based on an intention of the user to request waiting. For example, in a case where the display is a touch panel display, the operation of the user can be received by touching a touch panel corresponding to the waiting command button 84 with a finger or the like. When an operation with respect to the waiting command button 84 is received by the operation receiver 505, the waiting request processor 504 transmits a waiting request signal to the waiting command processor 307 of the vehicle management server 3 (see FIGS. 1 and 2), and a waiting request from the device 5 is performed.

In a case where an operation with respect to the cancel button 85 is received by the operation receiver 505, the ride reservation processor 501 transmits a reservation cancel request signal to the reservation adjuster 308.

In the screen 81 illustrated in FIG. 8A, the estimated bus arrival time 83 is in a format of time point, and may be displayed with a difference between the estimated bus arrival time and the current time point, that is, with a remaining time period.

FIG. 8B is a screen example for prompting a re-reservation of the user. A screen 86 illustrated in FIG. 8B is displayed on the display by the notification provider 502 (see FIG. 3) of the device 5 in response to the notification command signal in S210 illustrated in FIG. 7. As illustrated in FIG. 8B, the screen 86 includes a cancellation notification 87 that notifies the user of cancellation of the ride reservation.

Further, the screen 86 includes an OK button 88 and a next reservation button 89. The next reservation button 89 is a user interface for receiving an operation of the user based on an intention of the user to make a re-reservation. When an operation with respect to the next reservation button 89 is received by the operation receiver 505, a ride reservation is made by the ride reservation processor 501. When an operation with respect to the OK button 88 is received by the operation receiver 505, a series of processing for the current ride reservation at the device 5 ends.

### SPECIFIC EXAMPLE

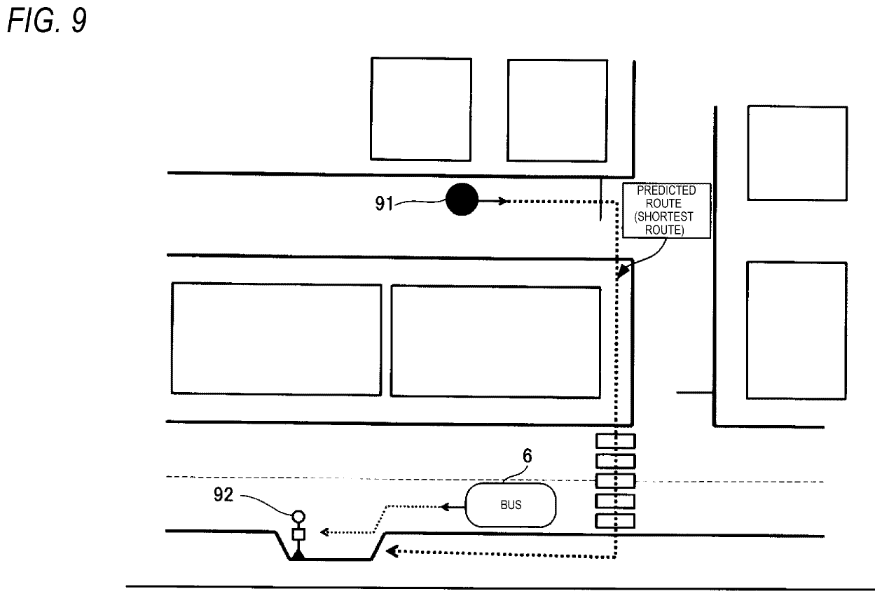

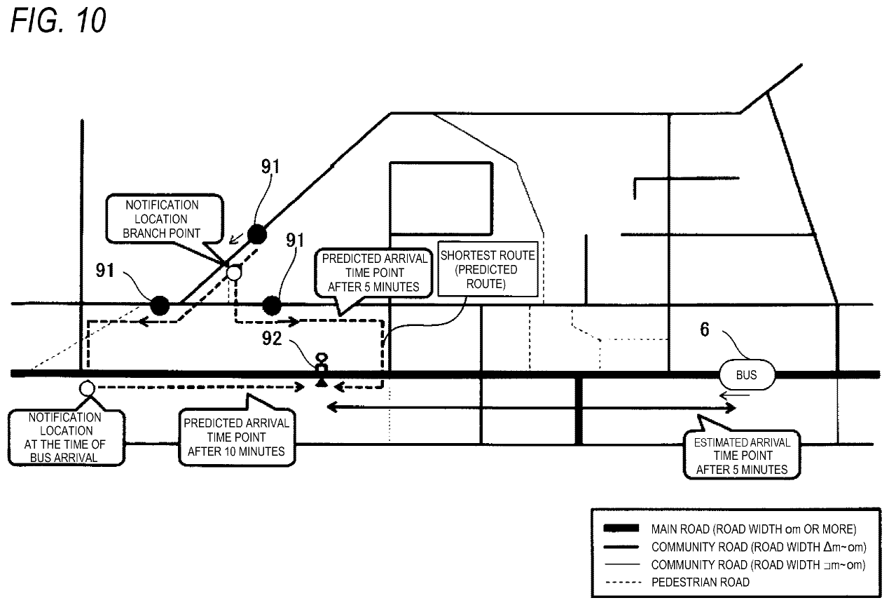

FIGS. 9 and 10 are illustrative diagrams illustrating a specific example of user support of the shared bus reservation system 1 according to the first embodiment.

In the following specific example, the route searcher 33 (see FIG. 1) of the vehicle management server 3 sets, as a predicted route, a shortest route between a location indicated by current location information of the device 5 and a bus stop.

FIG. 9 illustrates a case where there is one predicted route that is predicted to be used by a user 91 up to a bus stop 92. In a case where the user 91 moves along the predicted route, the user 91 moves away from the bus stop 92 for a short time, and a movement direction thereof is not directed to the bus stop 92. Even in such a case, there is no occurrence of canceling a ride reservation in the user support processing according to the first embodiment since the user does not deviate from the predicted route.

There may be a plurality of predicted routes. FIG. 10 illustrates a case where the predicted route predicted to be used by the user 91 up to the bus stop 92 includes two of a shortest route and a next shortest route (hereinafter, referred to as a “second shortest route”). In this example, in a case where the user 91 uses the shortest route, a predicted arrival time is 5 minutes after a current time point, and in a case where the second shortest route is used, a predicted arrival time is 10 minutes after the current time point. An estimated bus arrival time of the bus 6 is 5 minutes after the current time. Therefore, in the case of using the shortest route, the user 91 can arrive at the bus stop 92 by the estimated bus arrival time. On the other hand, in the case of using the second shortest route, the user 91 does not make it in time to the bus stop 92 by the estimated bus arrival time. In this case, when the bus 6 arrives, a bus arrival notification (S212 illustrated in FIG. 7) is performed to the device 5 (see FIG. 1).

In the example illustrated in FIG. 10, in a case where the estimated bus arrival time of the bus 6 is after 10 minutes or more, the user can arrive at the bus stop 92 by the estimated bus arrival time regardless of the shortest route or the second shortest route. Therefore, the user makes it in time even when selecting any one of the shortest route and the second shortest route. However, in the case where the estimated bus arrival time is after 5 minutes, a choice of the user is only the shortest route. Therefore, when a branch point illustrated in FIG. 10 is present on the route, the notification provider 305 (see FIG. 2) compares the estimated bus arrival time with the predicted arrival times of the user for using the respective shortest route and second shortest route. Further, in a case where it is determined that the user makes it in time using any one of the shortest route and the second shortest route, the notification provider 305 preferably causes a notification indicating that to be performed on the device 5 at the branch point.

As described, the predicted route is not limited to one. In addition, the shortest route is merely an example of a predicted route, and a route selected based on another criterion can be used as a predicted route.

(Hardware Configuration)

Note that a functional block diagram used in the description of the embodiment described above illustrates blocks of functional units. These functional blocks (components) are implemented by any combination of hardware and/or software. The implementation method of each functional block is not particularly limited. That is, each functional block may be implemented by one piece of apparatus that is physically coupled, or may be implemented by two or more pieces of physically separated apparatus which are connected by wire or wirelessly.

FIG. 11 is a diagram illustrating an example of a hardware configuration of the server and the device according to the first embodiment. The computer apparatus 1000, which constitutes the vehicle management server 3, the device 5, a vehicle onboard computer of the bus 6 and the like, may be physically configured as a computer apparatus 1000 that includes the processor 1001, a memory 1002, a storage 1003, a communication apparatus 1004, an input apparatus 1005, an output apparatus 1006, a sensor 1007, an internal bus 1008, and the like.

In the following description, the term “apparatus” can be replaced with circuit, device, unit, or the like. The hardware configuration may be configured to include each piece of apparatus illustrated in the drawing by one or more, or may be configured without including a part of the apparatus.

For example, only one processor 1001 is illustrated, and alternatively there may be a plurality of processors. The processing may be executed by one processor, or the processing may be executed concurrently, sequentially, or with another method, by one or more processors.

Each function of the vehicle management server 3, the device 5, the bus 6, and the like is realized by causing the processor 1001 to read predetermined software (program) on hardware such as the memory 1002 so that the processor 1001 performs calculation and controls communication performed by the communication apparatus 1004 and reading and/or writing of data in the memory 1002 and the storage 1003.

For example, the processor 1001 controls the entire computer by operating an operating system. The processor 1001 may be configured with a central processing unit (CPU) that includes a control apparatus, a calculation apparatus, a register, an interface with a peripheral apparatus and the like. The processor 1001 may be implemented by one or more chips.

The processor 1001 reads a program (program code), a software module, or data from the storage 1003 and/or the communication apparatus 1004 into the memory 1002, and executes various types of processing in accordance therewith. As the program, a program that causes a computer to execute at least a part of the operations described in the embodiment described above is used.

The memory 1002 is an example of the storages 34, 54, and 63 (see FIGS. 2, 3, and 4), is a computer-readable recording medium, and may be configured with, for example, at least one of a read only memory (ROM), an erasable programmable ROM (EPROM), an electrically EPROM (EEPROM), a random access memory (RAM), and another suitable storage medium. The memory 1002 may be called a register, a cache, a main memory (main storage apparatus), or the like. The memory 1002 can store a program (program code), a software module, and the like that can be executed to implement a ride reservation user support apparatus according to the present invention.

The storage 1003 is an example of the storages 34, 54, and 63 (see FIGS. 2, 3, and 4), is a computer-readable recording medium, and may be configured with, for example, at least one of a flexible disk, a floppy (registered trademark) disk, a magneto-optical disk (for example, a compact disk (CD-ROM (Compact Disc ROM)), a digital versatile disk, a Blu-ray (registered trademark) disk, a removable disk, a hard disk drive, a smart card, a flash memory device (for example, a card, a stick and a key drive), a magnetic stripe, a database, a server, and another suitable storage medium. The storage 1003 may be called an auxiliary storage apparatus.

The communication apparatus 1004 is an example of the communicators 35, 52, and 62 (see FIGS. 2, 3, and 4), is hardware (transmission and reception device) for performing communication between computers via a wired and/or wireless network, and is also called a network device, a network controller, a network card, a communication module, or the like.

The input apparatus 1005 is an example of the input interfaces 56 and 69 (see FIGS. 3 and 4), and is an input device (for example, a keyboard or a mouse) that receives input from the outside. The output apparatus 1006 is an example of the output interfaces 53 and 71 (see FIGS. 3 and 4), and is an output device (for example, a display or a speaker) that performs output to the outside. The input apparatus 1005 and the output apparatus 1006 may be an integrated configuration (for example, a touch panel).

Each piece of apparatus such as the processor 1001 and the memory 1002 is connected by an internal bus 1008 for communicating information.

The vehicle management server 3, the device 5, the vehicle onboard computer of the bus 6 and the like may be configured to include hardware such as a microprocessor, a digital signal processor (DSP), an application specific integrated circuit (ASIC), a programmable logic device (PLD), or a field programmable gate array (FPGA), and a part or all of the functional blocks may be implemented by the hardware. For example, the processor 1001 may be implemented by at least one type of the hardware.

In the first embodiment, the network used for communication between the cloud 2 (see FIG. 1) and the control device 7 includes various networks such as the Internet, a mobile network, a local area network (LAN), and a wide area network (WAN). The network may be configured to be wireless, wired, or a combination thereof. For example, as a wireless communication system, Bluetooth (registered trademark), wireless LAN (for example, conforming to the IEEE 802.11 standard), long term evolution (LTE), or another wireless communication system can be used.

The mobile communication network 4 (see FIG. 1) can use, for example, LTE or another wireless communication system.

As described above, according to the first embodiment, even in a case where the user is not using the predicted route to move to the bus stop, the intention of the user is confirmed and a countermeasure is taken in accordance therewith, and the convenience is improved and the influence on the operation schedule of the bus 6 can be reduced.

For example, in a case where the user has not arrived at the bus stop, by notifying the user of a scheduled bus arrival time and the bus arrival, the user can take a countermeasure such as changing the reservation for a next bus in an early stage or quickening the movement so as not to miss the bus, and scheduled operability of the bus 6 can be secured.

In the case where the user has not arrived at the bus stop, by confirming with the user the waiting necessity of the bus 6, it is possible to prevent the user from missing the bus 6 while minimizing the waiting time of the bus 6.

Further, since the user can confirm that the reservation is automatically cancelled and the next reservation can be immediately performed, the scheduled operability of the bus 6 can be secured while the convenience for the user is maintained.

### Second Embodiment

Next, a second embodiment will be described focusing on differences from the first embodiment. In the following description, the same configurations as those of the first embodiment are denoted by the same reference numerals, and a description thereof will be omitted.

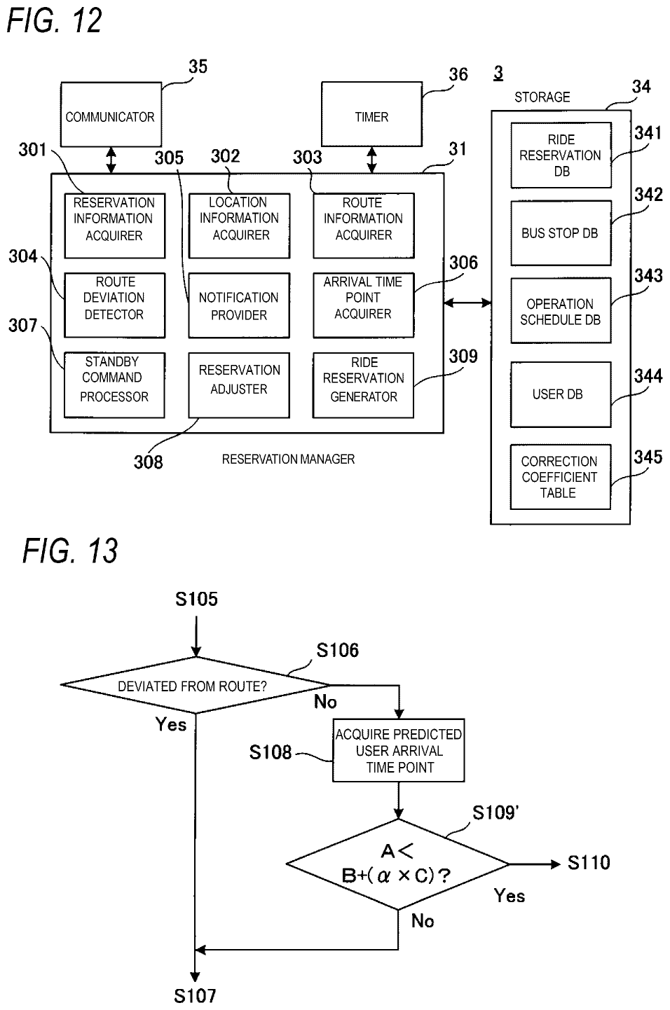

FIG. 12 is a functional block diagram illustrating a reservation manager of the vehicle management server 3 according to the second embodiment. A reservation manager 31 illustrated in FIG. 12 is different from that of the first embodiment in that the storage 34 stores a user database 344 and a correction coefficient table 345.

In the user database 344, attribute information related to movement of a user up to a bus stop is registered for each user. The attribute information includes, for example, age, presence or absence of pregnancy, presence or absence of physically handicapped person certification, presence or absence of wheelchair use, and presence or absence of use of a stroller, and is not particularly limited.

The correction coefficient table 345 determines a correction coefficient C for correcting predetermined periods of time α and β based on the attribute information. Table 1 illustrates an example thereof.

TABLE 1

| | | | | | | | OTHER |
|---|---|---|---|---|---|---|---|
| | | | | | | WHEEL- | INFOR- |
| AGE | ~5 | 10 | 20~60 | 70 | 80~ | CHAIR | MATION |
| CORRECTION | 1.1 | 1.05 | 1.0 | 1.1 | 1.2 | 1.5 | 1.5 |
| COEF- | | | | | | | |
| FICIENT C | | | | | | | |

In the first embodiment, in step S109 of the flowchart illustrated in FIG. 6, the notification provider 305 determines whether the user makes it in time based on whether the predicted user arrival time (A) is earlier than the estimated bus arrival time (B) (A<B). In the second embodiment, the estimated bus arrival time is adjusted in accordance with an actual circumstance of the user.

FIG. 13 is a flowchart illustrating a part of user support processing of a shared bus reservation system 1 according to the second embodiment. As illustrated in FIG. 13, in S109′, the notification provider 305 determines whether A<B+(α×C) is satisfied, and causes the notification provision processing (S107) to be performed if that is not satisfied (determination in S109′ is No).

That is, the predetermined time period α is added to the estimated bus arrival time B in consideration of a case where the user cannot arrive at the predicted user arrival time. The predetermined time period α can be optionally determined, for example, as 10 minutes. Further, the notification provider 305 acquires the correction coefficient C, which is determined in the correction coefficient table 345, based on the attribute information of the user, and uses the correction coefficient C to correct the predetermined time period α.

Accordingly, it is assumed that the user is predicted to be later than the estimated bus arrival time (B) by only the predetermined time period α, and the notification provision processing (S107) can be caused to be performed and correction in accordance with the attribute information of the user is made to the predetermined time period α. As a result, since it is possible to determine whether the notification provision processing (S107) is performed in accordance with an actual circumstance such as one that the user is elderly or one that the user uses a wheelchair, the convenience for the user can be further improved.

In the first embodiment, in the notification provision processing illustrated in FIG. 7, the reservation adjuster 308 cancels the ride reservation in the case where the predetermined time period t2 elapses after the stop confirmation notification is received from the bus 6 (S208, S209). In the determination here, a scheduled bus departure time point determined by the operation schedule is not taken into consideration.

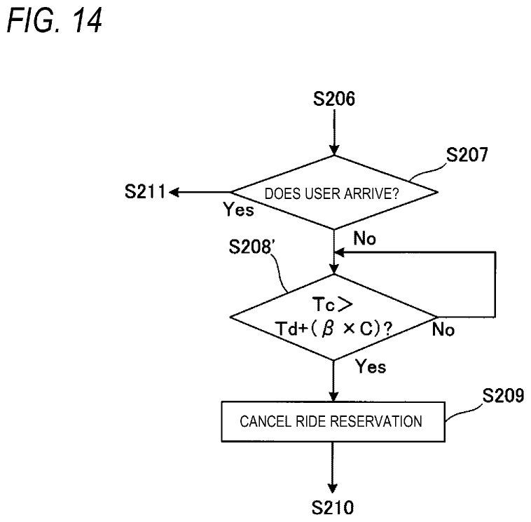

FIG. 14 is a flowchart illustrating a part of notification provision processing of the shared bus reservation system 1 according to the second embodiment. As illustrated in FIG. 14, in S208′, the reservation adjuster 308 determines whether Tc>Td+(β×C) is satisfied when the current time point is set as Tc, a scheduled departure time point as Td, the predetermined time period as β, and the correction coefficient as C. Further, cancellation of the ride reservation (S209) is performed if that is satisfied, and thereafter the waiting command processor 307 performs the waiting release transmission (S211 in FIG. 7).

That is, the adjustment is performed by adding the predetermined time period β to the scheduled departure time point Td such that there is no occurrence that the ride reservation is canceled (S209) immediately after the scheduled departure time point Td is reached. The predetermined time period β can be optionally determined, for example, as 10 minutes. Further, the reservation adjuster 308 acquires the correction coefficient C, which is determined in the correction coefficient table 345, based on the attribute information of the user, and uses the correction coefficient C to correct the predetermined time period β.

Accordingly, the cancellation of the ride reservation (S209) is performed after at least the predetermined time period β×the correction coefficient C elapses since the scheduled departure time point (Td), and the waiting command is canceled (S211) so that the bus 6 can depart from the bus stop. Therefore, a departure delay from the scheduled departure time point (Td) is reduced to a minimum necessary amount, and the correction in accordance with the attribute information of the user is made to the predetermined time period β. As a result, since it is possible to determine whether the notification provision processing (S107) is performed in accordance with an actual circumstance such as one that the user is elderly or one that the user uses a wheelchair, the convenience for the user can be further improved and the scheduled operability of the bus 6 can be improved.

Further, in the second embodiment, in a case where there is route deviation (determination in S106 of FIG. 6 is Yes) and in a case where the user does not make it in time by the time the bus 6 arrives (determination in S109 is No), the waiting of the bus 6 is performed from the scheduled departure time point (Td) to elapse of the predetermined time period β×the correction coefficient C. Therefore, since the waiting time of the bus 6 is adjusted in accordance with the actual circumstance of the user, the convenience for the user can be further improved.

Here, the predetermined time period β corresponds to a waiting time period of the bus 6 until the arrival of the user at the bus stop. Therefore, as illustrated in Expression (1), it is preferable to perform adjustment such that an integrated value of the predetermined time period β, that is, an accumulated time period is less than a maximum time period γ in one operation cycle (from a starting bus stop to a device bus stop).

Σβ<γ (Expression 1)

Accordingly, even in a case where the waiting request from the user continues for a long time period, it is possible to make up for the delay by adjusting the operation management and the vehicle control in the operation cycle, and thus it is possible to secure the scheduled operability of the bus 6.

In the second embodiment, the predetermined periods of time α and β are corrected in accordance with the attribute information of the user, and may be corrected with other added information (for example, a traffic congestion state of the operation route of the bus 6).

As described above, according to the second embodiment, the same effect as that of the first embodiment can be obtained, and the convenience for the user can be further improved by performing necessary user support in accordance with the attribute of the user, and the influence on the operation schedule of the bus 6 can be reduced.

According to the second embodiment, the waiting time of the bus 6 can be extended in accordance with age of the user and the like, and the influence on the operation schedule of the bus 6 can be minimized by performing adjustment within the maximum time period γ.

### Third Embodiment

Next, a third embodiment will be described focusing on differences from the first and second embodiments. In the following description, the same configurations as those in the first and second embodiments are denoted by the same reference numerals, and a description thereof will be omitted.

In the first and second embodiments, the user support processing ends in the case where the current location information of the device 5 (see FIG. 1) cannot be acquired in step S103 of FIG. 6, but the third embodiment is different from the first and second embodiments in that the user is supported as much as possible in such a case.

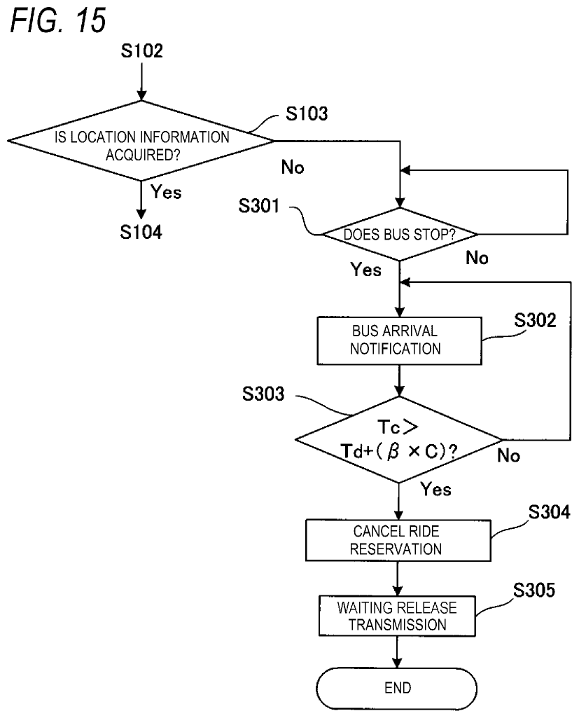

FIG. 15 is a flowchart illustrating a part of user support processing of the shared bus reservation system 1 according to the third embodiment. If it is determined in S103 that the current location information of the device 5 cannot be acquired, the notification provider 305 determines whether the bus 6 has stopped at the bus stop based on whether the stopping confirmation notification (S10 in FIG. 5) is received from the operation state notification generator 608 of the bus 6 (S301). If the determination in S301 is No, the process returns to S301. Therefore, S301 is repeated until the bus stops.

Next, the notification provider 305 transmits a notification command signal that commands performing of a bus arrival notification (S302). Thereafter, similarly to S208′ illustrated in FIG. 14, the reservation adjuster 308 determines whether Tc>Td+(β×C) is satisfied (S303). Further, cancellation of a ride reservation is performed in a case where that is satisfied (S304), and thereafter the waiting command processor 307 performs waiting release transmission (S305), and the processing ends. Here, the cancellation of the ride reservation (S304) and the waiting release transmission (S305) is the same processing as S209 and S211 in FIG. 7. After the cancellation of the ride reservation (S304) is performed, the notification provider 305 may transmit a notification command signal, which commands a notification of prompting a re-reservation of remaking a ride reservation, to the device 5 (see S210 in FIG. 7).

Accordingly, in a case where the current location information cannot be acquired from the device 5 and the location of the user cannot be detected, since it cannot be confirmed where a waiting command is transmitted from or there is a possibility that the user arrives at the bus stop, only the bus arrival notification can be performed without performing the waiting command. Even in a case where the current location information cannot be acquired from the device 5, waiting of the bus 6 is performed. After at least the predetermined time period β×the correction coefficient C elapses since the scheduled departure time point (Td), cancellation of the ride reservation (S209) is performed, and the waiting command is released (S211) so that the bus 6 can depart from the bus stop.

In the case where the current location information cannot be acquired from the device 5 (see FIG. 1), the following situations are included.
(1) A network line (such as the mobile communication network 4) between the device 5 and the vehicle management server 3 is not stable.
(2) The device 5 cannot receive a GNSS signal from the GNSS satellite 8.
(3) Power of the device 5 is turned off, or the device 5 is out of reach of radio waves.
(4) An error range of the location indicated by the current location information of the device 5 is a predetermined range (for example, 200 m) or more.
(5) The location indicated by the current location information of the device 5 is not stable (for example, movement of 100 m or more is repeated within a predetermined time period).

For example, even in a situation where the network line is not stable as in (1), it is preferable that the notification is performed when the network line is stable and the communication is restored. For example, in the present embodiment, as described with reference to FIG. 6, the notification provider 305 determines whether a stopping confirmation notification (S10 in FIG. 5) is received from the bus 6 (S110), and if the determination is Yes, the notification provider 305 transmits the notification command signal that commands performing of the bus arrival notification (S111). Accordingly, when the communication is restored, the user can know that the bus 6 arrives at the bus stop, and thus the convenience for the user is further improved.

As described, even in the case where the current location information cannot be acquired from the device 5, it is possible to avoid an inconvenient situation from occurring, in which the ride reservation is immediately cancelled for a reason that the current location information cannot be acquired from the device 5 and in which the bus 6 is caused to wait more than necessary.

As described above, according to the third embodiment, the same effects as those of the first and second embodiments can be obtained, the convenience for the user can be improved even in a situation where the device 5 cannot perform communication, and the influence on the operation schedule of the bus 6 can be minimized.

For example, in a case where the current location information of the device 5 cannot be acquired by the location information acquirer 302 (see FIG. 2), the waiting command processor 307 can transmit a waiting command signal to the bus 6 so that the bus 6 can be caused to wait even when the device 5 cannot perform communication.

Further, the reservation adjuster 308 corrects the predetermined time period β with the correction coefficient C based on the attribute information of the user, so that it is possible to secure the waiting time in accordance with the actual circumstance of the user and it is possible to prevent the waiting from being extended more than necessary.

Although the present embodiment and a modification have been described, the present embodiment and the modification may be combined entirely or partially as another embodiment of the present invention.

Embodiments of the present invention are not limited to the embodiments described above and various changes, substitutions and modifications may be made without departing from the scope of the technical idea of the present invention. The technical idea of the present invention may be implemented in other ways if the technical idea can be realized in these ways due to technological advancement or other deriving techniques. Accordingly, the claims cover all embodiments that may fall within the scope of the technical idea of the present invention.

For example, in the embodiments described above, the ride reservation user support apparatus is implemented by a part (reservation manager 31) of the vehicle management server 3 provided in the cloud 2 (see FIG. 1), and alternatively may be implemented by, for example, a vehicle onboard apparatus such as a car navigation apparatus mounted on the bus 6, a mobile communication apparatus such as a smartphone used by the user, a server provided on-premise, or an information processing apparatus such as a personal computer used by a person in charge of control.

In the embodiments described above, the vehicle management server 3 realizes all the functions of the reservation manager 31, the operation manager 32, and the route searcher 33, and it is also one of the embodiments of the present invention, in which these functions are realized by separate servers and the servers operate in conjunction to realize the functions equivalent to those of the vehicle management server 3.

As described above, the present invention has the effects that the convenience for the user can be improved and the delay of the vehicle operation schedule can be prevented, and is particularly useful for an automatic driving shared bus.

What is claimed is:

1. A ride reservation user support apparatus, comprising:
a reservation information acquirer configured to acquire ride reservation information for identifying a device of a user and a scheduled boarding location where the user boards a vehicle;
a location information acquirer configured to acquire location information of the device;
a route information acquirer configured to acquire route information that indicates a predicted route, which is predicted to be used by the user, from a location indicated by the location information to the scheduled boarding location;
a route deviation detector configured to determine whether the device deviates from the predicted route based on the location information and the route information; and
a notification provider configured to cause the device to provide a notification to the user in a case where the device deviates from the predicted route.

2. The ride reservation user support apparatus as claimed in claim 1, wherein
the predicted route includes a shortest route from the location to the scheduled boarding location.

3. The ride reservation user support apparatus according to claim 1, wherein
the notification includes a predicted vehicle arrival time at which the vehicle arrives at the scheduled boarding location.

4. The ride reservation user support apparatus according to claim 1, wherein
the notification includes a confirmation of waiting necessity of the vehicle with the user.

5. The ride reservation user support apparatus according to claim 1, further comprising:
an arrival time acquirer configured to acquire a predicted user arrival time at which the user arrives at the scheduled boarding location, based on the location information acquired by the location information acquirer, wherein
the route deviation detector causes the device to provide the notification to the user in a case where the predicted user arrival time is later than the predicted vehicle arrival time at which the vehicle arrives at the scheduled boarding location.

6. The ride reservation user support apparatus according to claim 1, further comprising:
a reservation adjuster configured to cancel a ride reservation by the user after a predetermined time period elapses from a scheduled departure time point of the vehicle from the scheduled boarding location, in a state where the vehicle waits.

7. The ride reservation user support apparatus according to claim 6, wherein
the reservation adjuster adjusts the predetermined time period based on attribute information of the user.

8. The ride reservation user support apparatus according to claim 6, wherein
the reservation adjuster adjusts the predetermined time period such that an accumulated time period of the predetermined time period is less than a maximum time period in one operation cycle.

9. The ride reservation user support apparatus according to claim 6, wherein
in a case where the ride reservation is canceled, the notification includes contents for notifying the user of the cancellation of the ride reservation and prompting a re-reservation.

10. The ride reservation user support apparatus according to claim 6, further comprising:
a waiting command processor configured to command the vehicle to wait in a case where the location information acquirer is not able to acquire the location information of the device.

11. The ride reservation user support apparatus according to claim 6, wherein
in the case where the location information acquirer is not able to acquire the location information of the device, the notification provision unit provides to the device a notification indicating that the vehicle arrives at the scheduled boarding location.

12. A ride reservation user support method, comprising:
a step of acquiring ride reservation information for identifying a device of a user and a scheduled boarding location where the user boards a vehicle;
a step of acquiring location information of the device;
a step of acquiring route information that indicates a predicted route, which is predicted to be used by the user, from a location indicated by the location information to the scheduled boarding location;
a step of determining whether the device deviates from the predicted route based on the location information and the route information; and
a step of causing the device to provide a notification to the user in a case where the device deviates from the predicted route.
